(19) United States
(12) Patent Application Publication
(10) Pub. No.: US 2009/0074928 A1
(43) Pub. Date: Mar. 19, 2009

(54) IMAGE CREATING APPARATUS AND METHODS OF USE

(76) Inventor: Oleksiy Pikalo, Somerville, MA (US)

Correspondence Address: JOHN J. BROOKS, III, 20 WYSTERIA WAY, WRENTHAM, MA, 02093, US

(21) Appl. No.: 12/211,042

(22) Filed: Sep. 15, 2008

Related U.S. Application Data
(60) Provisional application No. 60/973,040, filed on Sep. 17, 2007.

(51) Int. Cl. A23P 1/08; B05C 11/02; A23G 3/02

(52) U.S. Cl. 426/383; 118/46; 118/13

(57) ABSTRACT

A image creating apparatus, said apparatus comprising a printing assembly having a reservoir and at least one opening, the reservoir containing a liquid substance, surface of a liquid sublayer and the printing assembly further comprises a means to release the substance from the opening onto the surface. Embodiments of the apparatus are capable of creating and reproducing images on non-uniform and liquid surfaces.

### CROSS-REFERENCE TO RELATED APPLICATIONS

This application claims the benefit of U.S. App. No. 60/973,040, entitled “Method of Displaying Images on the Surface of a Beverage” filed on 17 Sep. 2007, the entire contents of which are incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to printing on non-uniform surfaces and more particularly to creating images on a liquid surface or a surface floating on a liquid.

2. Description of the Prior Art

The appeal of media figures, the benefits of vendor branding and the desire to advertise have always created a source of images to display for promotion, branding and advertising.

Food vendors have used multiple techniques to provide these images. In the case of food vendors, printing with edible inks well known in the art.

Computer and computer printers have been popular for many years providing solutions that allow edible images to be created by printing directly on baked goods, or separately printing on a sheet and placing it on the good. One common method of printing on baked goods is used with decorating cakes. Many of these methods comprise printing on a surface such as sugar sheets, edible paper, icing or a glaze. In these embodiments that print on one surface to be transferred to the edible item, many of the features used in normal printing have simply been transferred to the new printing surface. For example, rather than printing on a piece of paper, these new embodiments print on an edible paper like substance such as rice paper or sugar sheets. Other embodiments include forming a paper-like smooth surface on the frosting of the cake. With both of these types of solutions, unexpected problems associated with printing directly onto all baked goods have not been addressed. For example, printing on a non-uniform surface creates problems with the ability to transfer the ink onto the surface while still controlling the reproduction of the image. Typical designs of inkjet cartridges provide for a controlled ink deposit at close range, but the ink deposited at longer ranges is very difficult to control, typically resulting in significantly reduced control of the final printed image.

These embodiments for baked goods also fail to address additional difficulties encountered when trying to print on a liquid surface. Depositing inks on uniform liquid surfaces can cause the inks to immediate disperse into or across the surface either preventing the creation of an image or seriously detracting from the appeal of the intended image. Additionally, many traditional inks are colored with a mixture of pigments that create multiple color spectrums when dissolved in a liquid. If these inks are used to print on a liquid, the multiple color spectrums also detract from the appeal of the original image. In addition, depositing inks on uniform liquid surface can cause the inks to immediate disperse or run again detracting from the appeal of the intended image.

For decorating beverages such as coffees, hand made images created from the mixture of the cream with the coffee is difficult to master and very difficult to incorporate detailed images. Images with the detail normally associated with computer inkjet printers are not possible with these methods.

Any application of these prior art solutions to the situation of printing on non-uniform surfaces or printing on liquid surfaces would fail to address many of these and other unexpected challenges.

### BRIEF SUMMARY OF THE INVENTION

One embodiment of the invention comprises an image creating apparatus comprising a printing assembly having a reservoir and at least one opening, the reservoir containing a liquid substance, a surface of a liquid sublayer and the printing assembly further comprises a means to release the substance from the opening onto the surface.

Another embodiment of the invention comprises an image creating apparatus wherein the surface comprises a foam surface on the liquid sublayer.

Yet another embodiment of the invention comprises an image creating apparatus wherein the surface comprises a liquid film surface on the liquid sublayer.

One embodiment of the invention comprises an image creating apparatus wherein the means to release the substance from the opening onto the surface is capable of releasing the substance at a resolution of at least about 10 dots per inch.

Another embodiment of the invention comprises an image creating apparatus wherein the liquid substance comprises a coloring having a uniform color spectrum as the substance dissolves in the liquid sublayer.

Yet another embodiment of the invention comprises an image creating apparatus wherein the liquid sublayer includes a coloring having a color spectrum and the liquid substance includes a coloring having the same color spectrum.

One embodiment of the inventions comprises an image creating apparatus wherein the liquid substance is ingestible and the surface is ingestible.

Another embodiment of the invention comprises an image creating apparatus wherein the liquid substance comprises a caramel, the surface comprises a dairy based foam surface and the surface is floating on the liquid sublayer comprising a coffee based liquid.

Yet another embodiment of the invention comprises an image creating apparatus wherein the means to release the liquid substance comprises an actuation assembly and the actuation assembly comprising a power source, a resistor proximal to the opening and a control panel electronically connected to the resistor whereby the actuation assembly is capable of transferring a pulse of electrical current from the power source to the resistor to release the liquid substance.

One embodiment of the invention comprises an image creating apparatus wherein the printing assembly further comprises a movement assembly and a processor based control assembly, the movement assembly is capable of moving the opening in at least two dimensions and the processor based control assembly comprises a processor, memory and computer executable code capable of communicating with the movement assembly and the actuation assembly.

One embodiment of the invention comprises an image creating apparatus to create an image, said apparatus comprising a printing assembly comprising a reservoir and at least one opening, the reservoir containing a liquid substance; and an actuation assembly to release the liquid substance from the at least one opening across a plurality of distances onto a surface to create an image having a resolution on the surface of at least about 10 dots per inch.

Another embodiment of the invention comprises an image creating apparatus wherein the actuation assembly comprises a power source, a resistor proximal to the opening and a control panel electronically connected to the resistor whereby the actuation assembly is capable of transferring a pulse of electrical current from the power source to the resistor to release the liquid substance.

Yet another embodiment of the invention comprises an image creating apparatus wherein the plurality of distances varies more than about 5 millimeters.

One embodiment of the invention comprises an image creating apparatus wherein the plurality of distances is at least about 5 millimeters.

Yet another embodiment of the invention comprises an image creating apparatus wherein the printing assembly further comprises a movement assembly and a processor based control assembly, the movement assembly is capable of moving the opening in at least two dimensions and the processor based control assembly comprises a processor, memory and computer executable code capable of communicating with the movement assembly and the actuation assembly.

One embodiment of the invention comprises a method of creating an image comprising the steps of providing a printing assembly comprising a reservoir with at least one opening, providing a liquid substance contained in the reservoir, providing a surface on a liquid sublayer and releasing the liquid substance from the at least one opening onto the surface to create an image.

Another embodiment of the invention comprises a method of creating an image wherein the step of providing a surface comprises providing a foam surface floating on the liquid sublayer.

Yet another embodiment of the invention comprises a method of creating an image wherein the step of providing a surface comprises providing a liquid film surface floating on the liquid sublayer.

One embodiment of the invention comprises a method of creating an image wherein the step of providing a surface comprises agitating a liquid toplayer to create a surface of a mass of bubbles of gas in a matrix of liquid toplayer film.

Another embodiment of the invention comprise a method of creating an image wherein the step of releasing the substance comprises moving the at least one opening over the surface with a movement assembly, releasing the liquid substance from the reservoir with an actuation assembly and controlling the movement assembly and the actuation assembly with a control assembly whereby the release of the liquid substance onto the surface creates an image having a resolution on the surface of at least about 10 dots per inch.

Yet another embodiment of the invention comprises a method of creating an image wherein the control assembly is capable of storing an image in a memory and the step of controlling the movement assembly and the actuation assembly further comprising retrieving the image from the memory and communicating with the movement and actuation assembly to create the image from the memory.

One embodiment of the invention comprises a method of printing an image comprising the steps of providing a printing assembly comprising a reservoir with at least one opening, providing a liquid substance contained in the reservoir; providing a non-uniform liquid surface; and releasing the substance from the at least one opening across a plurality of distances onto the non-uniform liquid surface to create an image having a resolution on the surface of at least about 10 dots per inch.

Another embodiment of the invention comprises a method of creating an image wherein the non-uniform liquid surface comprises a non-uniform liquid surface on a liquid toplayer.

The above and other objects, features and advantage of the present invention will become apparent from the following description read in conjunction with the accompanying drawings, in which like reference numerals designate the same elements.

### BRIEF DESCRIPTION OF THE SEVERAL VIEWS OF THE DRAWINGS

FIG. 1. An overall diagram of one embodiment of the image creating apparatus.

FIG. 2. A side perspective view of one embodiment of the printing assembly.

FIG. 3A. A side view of one embodiment of the cartridge.

FIG. 3B. A bottom view of one embodiment of the cartridge.

FIG. 4. A partial top perspective view of one embodiment of the movement assembly and the cartridge.

FIG. 5. A schematic view of one embodiment of the control assembly.

FIG. 6. A side perspective view of a cross-section of a cup with a sublayer and a foam surface.

FIG. 7. A process diagram of one embodiment of the operational use of one embodiment of the image creating apparatus.

FIG. 8. A side perspective view of a hand held embodiment of the printing assembly.

FIG. 9A. A bottom view of the hand held embodiment of the printing assembly.

FIG. 9B. A bottom view of the hand held embodiment of the printing assembly showing internal elements.

### DETAILED DESCRIPTION OF THE INVENTION

An image creating apparatus and methods of use is described in detail with reference to the accompanying drawings. It will be appreciated that, while the following description focuses on an image creating apparatus and methods of use that allow printing on a layer of liquid foam on the top of a beverage, the systems and methods disclosed herein have wide applicability. For example, the image creating apparatus described herein may be readily employed with non-ingestible inks and layers, non-liquid foam, or any non-uniform surfaces. Notwithstanding the specific example embodiments set forth below, all such variations and modifications that would be envisioned by one of ordinary skill in the art are intended to fall within the scope of this disclosure.

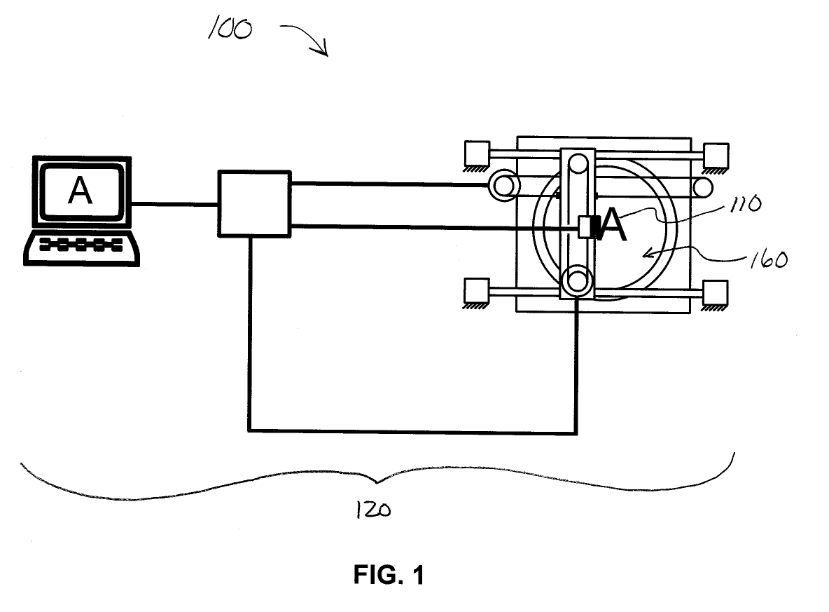

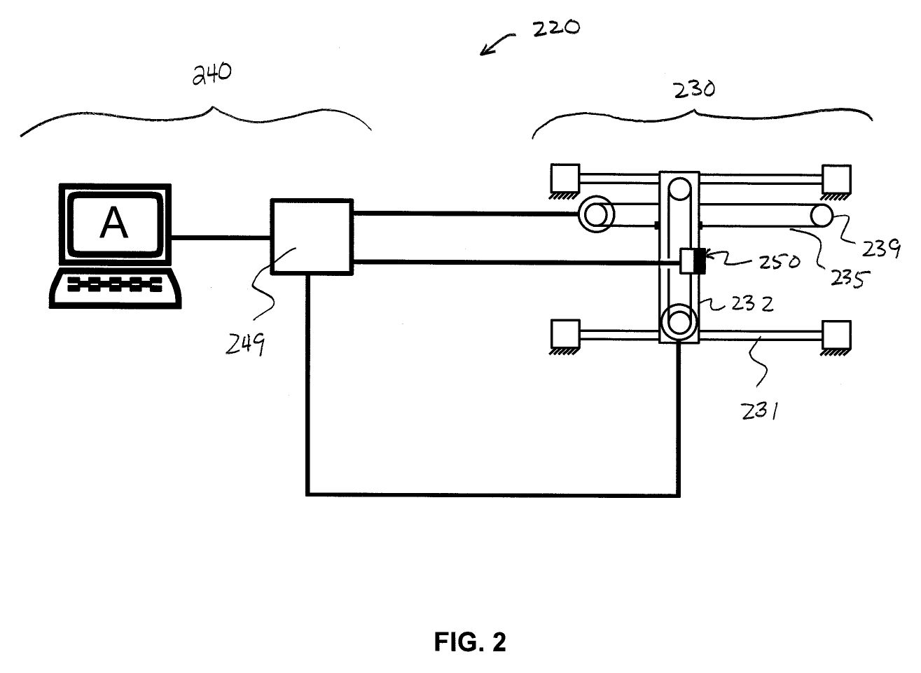

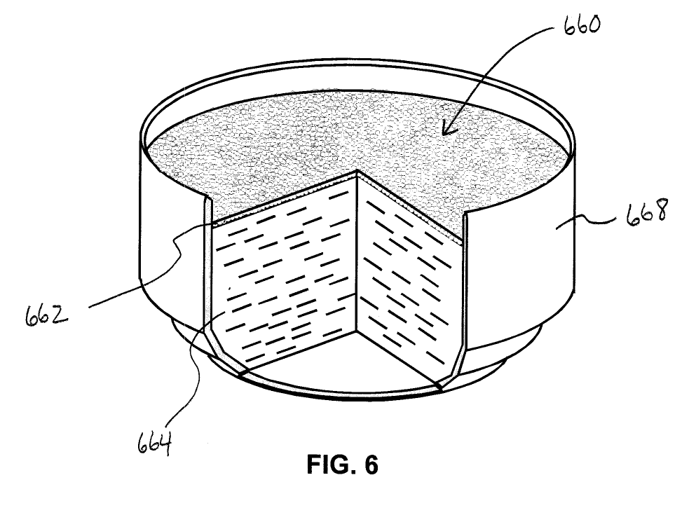

One embodiment of the image creating apparatus is illustrated in FIG. 1. As shown, the image creating apparatus 100 comprises a printing substance, a printing assembly 120, and a surface 160 to receive the printing substance. The printing assembly is shown in more detail in FIG. 2 where the printing assembly 220 comprises a cartridge 250, a movement assembly 230, a control assembly 240 that includes a control panel 249 to control the position of the cartridge and an actuation assembly to actuate the release of the substance from the opening. As shown in FIG. 6, the embodiments of FIG. 1 and FIG. 2 are used to print on a surface 660 such as the surface 660 of a liquid toplayer 662 above a liquid sublayer 664 in a cup 668.

The term solvable as used throughout this specification means susceptible of being dissolved in a fluid.

The term color spectrum, and spectrum, as used throughout this description means the range of wavelengths of electromagnetic radiation normally visible to the human eye, usually from 380 to 760 nm.

The term Dots Per Inch, or DPI, as used throughout this description is a measure of printing resolution, in particular the number of individual dots of a coloring substance that a cartridge can produce within a linear one-inch (2.54 cm) space. DPI is also used in this description to define the resolution of an image on a surface in dots of a coloring substance on the surface within a linear one-inch space.

### The Printing Substance:

The substance contained in the cartridge, such as an ink, is used to create a visible mark on the top layer surface. The substance comprises a material with a coloring that is compatible with the characteristics of the cartridge and able to sustain a visible mark on the surface for a long period of time. A substance having a color intensity of anywhere between 0.2 and 0.04 has been able to have a sufficient contrast to the surface. This intensity is measured as the absorbance of 0.1% solution at the wavelength of selected color through a 1 cm square cell on spectrometer. The coloring of the substance can be provided by a food coloring, an ink, a pigment, a dye or any combination thereof. Preferable colorings have high molecular weight component, such as polymeric caramels, whose color spectrum properties match the final desired spectrum of the printing substance and the spectrum properties of the liquid sublayer that may be under the printing surface. If multiple inks, pigments or dyes are utilized as coloring in a substance to match the color spectrum of the liquid sublayer, the mixing of the non-solvable colorings with different color spectrums should be avoided, to prevent the situation where the non-solvable components dissolve at different rates. For the same reasons, where multiple colors are necessary, it is preferable to use solid inks, pigments or dyes separately, rather than obtaining different color spectrums by mixing fundamental colors together.

For embodiments of the apparatus where the printing surface is non-permanent, the printing substance should also be non-intrusive to the sublayer beneath the surface. For example, when the toplayer is an ingestible beverage, if possible, the printing substance should not introduce additional types of chemicals to the beverage and should not change the color, taste or aromatic properties of the beverage.

For liquid embodiments of the substance, the liquids should also be capable of passing through a cartridge opening with a consistency of not clogging the opening of the cartridge during operation. Liquids with a viscosity range of about 2 to 250 cps (centipose) @ 20 C are suitable for embodiments of this invention that use cartridges similar to inkjet printing cartridges described herein. Suitable liquid substances include but are not limited to an aqueous ink formulation, a food coloring or any liquid formulation having a combination of one or more pigments or dyes and a liquid. Sweeteners, emulsifiers and humectants may also be added to create suitable liquid substances. Examples of suitable liquid substances include “Professional Quality Liquid Food Coloring, Caramel” distributed by LorAnn Oils of Lansing Mich., “Professional Quality Liquid Food Coloring, Brown” also of LorAnn Oils, “Liquid Caramel Color 050” and “Organic Caramel Color” distributed by DD Williamson & Co, Inc. of Louisville Ky.

For one embodiment, where the printing surface is a layer of milk foam and the underlayer is a coffee beverage, the printing substance is a mixture of water and a caramel. After some experimentation it was determined that a substance with a viscosity of 5 to 250 cps @ 20 C, or preferably a viscosity of 50 to 150 cps @ 20 degrees C. is sufficient for use as a liquid substance. It is possible to obtain a caramel with really high color intensity. Caramel food coloring is readily available with high color intensity of anywhere between 0.2 and 0.04 absorbance of 0.1% w/v (weight in volume) solution at 610 nm through a 1 cm square cell on a spectrophotometer. By its nature, the non-solvable polymeric caramel colorants do not degrade or dissolve on the milk foam. Another benefit of this embodiment is that the caramel spectrum matches the color spectrum of the roasted coffee beans and the spectrum of the beverage, since during roasting of the beans, caramelization occurs as intense heat breaks down starches in the bean, changing them to simple sugars that begin to brown, changing the color of the bean. In addition, since the color of the bean is obtained from the caramelization of natural sugars, no additional chemicals are added to the beverage. It is also possible to obtain such coloring with additional properties of being: organic, kosher, halal certified, and with no allergens and minimum sulfite levels. Additionally, the typical shelf life for caramel color is on the order of 2 years, if properly stored in closed containers under ambient conditions (<22 C and <60% relative humidity).

Other types of printing substance may be used, including particular components of the beverage itself. In these embodiments, a small amount of the beverage can be extracted from under the printing surface prior to the printing process, retained in the reservoir and released through the openings.

It is also contemplated that embodiment of the substance can include multiple liquid substances. Examples of suitable colored substances include “PhotoFrost Edible Colors” distributed by PhotoFrost Decorating Systems of Williston, Fla.

### The Printing Assembly:

The printing assembly provides the functional elements to hold, control and release the printing substance onto the surface. This printing assembly can comprise only a few elements such as a reservoir to hold the substance, an opening to release the substance, a means to move and control the opening and a means to release the substance from the opening. One embodiment, as shown in FIG. 2, and described in detail below, comprises a cartridge 250 having a reservoir and an opening, a movement assembly 230, a control assembly 240 to control the position of the opening and actuation assembly to actuate the release of the substance from the opening.

### The Cartridge

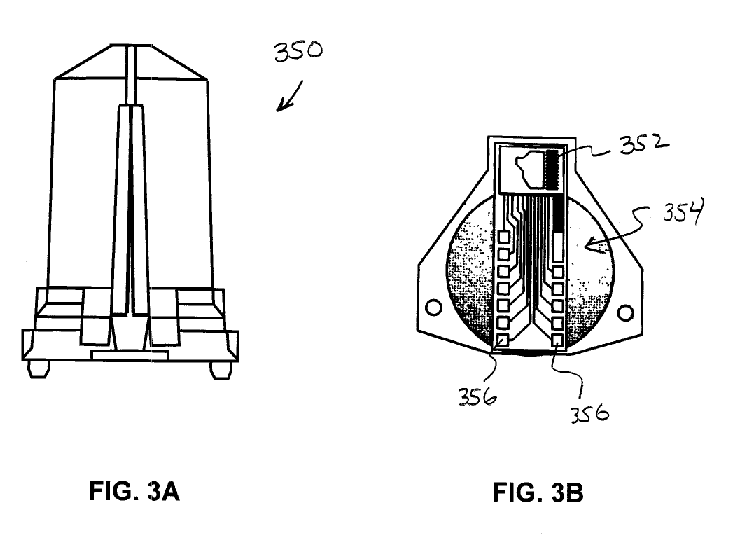

As shown in FIGS. 3A and 3B, one embodiment of the reservoir and opening comprises a cartridge 350. The reservoir 354 holds the printing substance and the opening 352 includes one or more openings to release it. The reservoir 354 is a containment area capable of retaining the printing substance. Typically, the reservoir retains a liquid printing substance and is small enough to allow the cartridge to be easily moved by the movement and control means of the apparatus. It is understood that a separate container can be used to store ink or other printing substance for the ease of refilling, connecting to the cartridge with an ink tube. The openings 352 are of a size to control the release of the printing substance. One embodiment of the opening includes those openings used in inkjet printing cartridges. These embodiments include a matrix of openings 352 creating nozzles.

As discussed later, the cartridge 350 also includes components to help actuate the release of the printing substance from the opening. A suitable means of releasing the substance comprises a resistor proximal to the opening and electrical interconnection points 356 to allow the resistor to communicate with other apparatus elements.

Working together, the opening 352, the substance and the means of releasing the substance should be capable of creating the image on the printing surface. Although any resolution of the image may be sufficient based on the content and use of the image, cartridges capable of printing common DPI resolutions can provide detailed images. Examples of cartridges with suitable DPI resolution ranges to create detailed images include cartridges with a DPI between 10 and 1200, or preferably between 96 and 1200 DPI or more preferably 96 and 300 DPI. The higher the DPI resolution of the cartridge is beneficial when trying to have a more detailed or higher resolution image on the surface.

Typical inkjet print cartridges used in a liquid based inkjet printing system are suitable for use with this apparatus. Examples of suitable cartridges include the HP TIJ 1.0 thermal inkjet print cartridges sold by Hewlett Packard of San Diego Calif. For one embodiment of the cartridge, a modified HP 51604 inkjet cartridge was used. The original ink was contained within a rubber balloon inside the cartridge. The bladder was removed entirely and the reservoir was filled with caramel food coloring with properties described above. In this embodiment the cartridge had 12 inline nozzles that span a 0.125″ printing swath height.

It is also contemplated that different cartridges, with different opening configurations and wider printing swaths are suitable for use and will also provide a solution with a faster printing speed.

### The Means to Release

The means to release of the printing substance comprises any method of releasing the printing substance from the cartridge openings. Examples of this means includes without limitation a physical trap covering the opening that is hinged or otherwise opened or methods utilized in inkjet printing cartridges.

In the embodiment shown in FIGS. 3A and 3B, the means to release is provided by an actuation assembly. This actuation assembly comprises a power source, a resistor placed proximal to the cartridge opening 352, a control panel and an electrical connection 356 to transmit pulses of electrical current from the power source to the resistor. The power source and the control panel in this embodiment is integrated with the control panel and control assembly as shown in FIG. 2.

In this embodiment, the operation is such that ink from the cartridge flows to the nozzle plate where, by capillary action, the ink forms a small meniscus of ink in each of the twelve nozzles. Within each nozzle the small resistor heats up rapidly when the current flows through it from the control panel. The resistor is heated by the pulse of electrical current causing the ink to vaporize off the nozzle, fly through the air, and land on the printing surface. With this embodiment, when a proper amount of energy is provided to vaporize the ink, it is possible to produce images on uneven surfaces, by shooting the ink through the air over a distance of over 13 mm.

The means to release is typically capable of spanning a gap between the opening and the printing surface of at least about 2 mm, preferably at least about 5 mm and more preferably at least about 13 mm.

In the embodiment comprising a milk foam surface and caramel based printing substance, the control panel was set to print a resolution of 96 dpi, which was sufficient for printing on the foam. Through repeated experimentation, a suitable pulse width to be sent to the resistor comprised a pulse of 6.0 μsec and height of 21 volts, with pulse repetition rate of 800 μsec (resulting in about 40 micro joules of energy during any one pulse into 65 Ohm resistor). This configuration delivered good results across a distance of about 13 millimeters from the nozzle opening to the printing surface. With this embodiment, the average droplet size was approximately 220 pl, and therefore the amount of caramel added to the beverage is so small that its taste (or smell) is indistinguishable from the taste of the beverage itself. In some embodiments, the actuation of the release was controlled to compensate for limitations concerning the number of nozzles that should fire at any given moment of time. Because of the manner in which the nozzles self-load with printing substance and the limited amount of firing energy that could be effectively delivered to the print head, the control panel was configured so that no more than two nozzles were fired at one time. In this embodiment, it was also preferred to only fire from the nozzles that are physically separated from each other at any given moment of time.

An example of a suitable actuation assembly comprises the actuation assemblies used in the KODAK DICONIX 150+ model printers and the 51604 model cartridges sold by Hewlett Packard of San Diego, Calif.

The embodiment above is an example of an embodiment capable of dealing with the non-uniform distances that the printing substance must travel while still controlling the image creation on surfaces such as foam or other masses of bubbles.

The means to release is capable of releasing the printing substance onto a surface that has a variability of distance from the opening of about 2 mm, or preferably about 5 mm and more preferably about 13 mm. This variability of distance reflects the peaks and the valleys of a non-uniform printing surface. Examples of where this variability may exist include, but are not limited to the surface of a piece of textured paper, a surface of a frosted cake or the surface of a layer of foam on a coffee beverage.

Although multiple control panels are described in different elements of this apparatus, it is understood that the control panels can be split into multiple boards, or they can be integrated into a single control panel or consolidated directly into elements such as the cartridge.

### Means to Move the Opening

The means to move the opening includes any method of moving the opening over a surface. For example, it is possible to move only the opening of the cartridge about the surface with the cartridge staying still or moving the cartridge and opening about the surface. It is also possible to move the opening by moving a self contained cartridge by hand over the printing surface.

For the embodiment shown in FIG. 2, the means to move the opening in at least two dimensions is provide by the movement assembly 230. The mechanisms typically used in flatbed plotters to move pens are examples of one suitable mechanism to move the cartridges in this apparatus. An example of printer that contains suitable movement assemblies includes the PM 8155 plotter made by Royal Philips Electronics of Amsterdam, Netherlands.

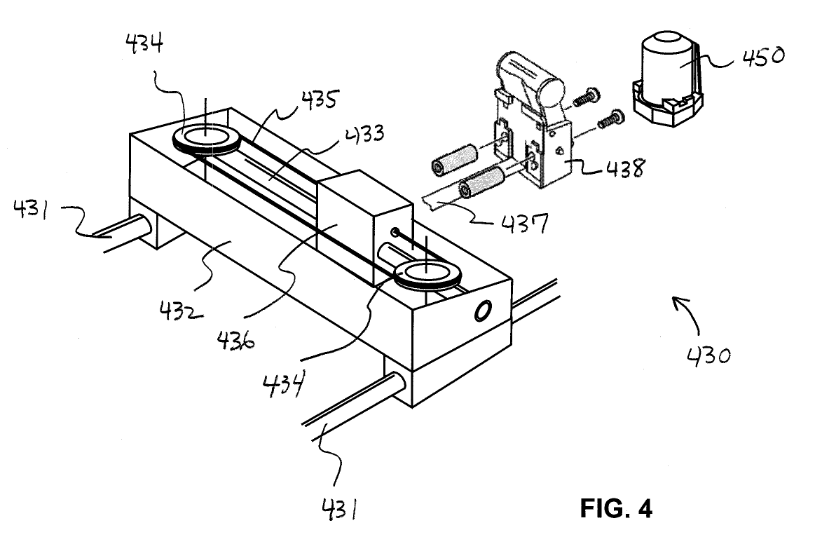

FIG. 4 shows a partial, and partially exploded view of one embodiment of the movement assembly 430 comprising a control panel, one or more longitudinal rails 431, a frame 432, one or more transverse rails 433, a fly-wheel and pulley assembly 434, a traditional base assembly 436, a signal cable 437 and a cartridge mounting base 438. This embodiment provides a movement assembly 430 that moves the cartridge 450 along two axes. The control panel contains processing capability to provide instructions to be translated and sent to other movement assembly components. The control panel can also be capable of receiving and translating instructions to and from other apparatus elements such as the actuation assembly. The longitudinal rails 431 provide a track on which the frame 432 moves in a longitudinal direction. The frame holds the transverse rails 433, the fly-wheel and pulley assembly 434, the belt 435, the traditional base assembly 436 and the cartridge 450. The transverse rails 433 provide a track on which the traditional base assembly 436 moves in a transverse, or perpendicular to the longitudinal rails 431, direction. The fly-wheel and pulley assembly 434 provides a movement mechanism to move the traditional base assembly 436 along the transverse rails 433. The movement mechanism receives instructions from the control panel which rotates the fly-wheel that engages the belt 435 that bi-directionally moves the traditional base assembly 436 along the transverse rails 433. In this embodiment, the traditional base assembly 436 comprises a mounting base for the cartridge 450 and the cartridge mounting base 438. The cartridge 450 is mounted onto the traditional base assembly 436 and is also connected to control board by a signal cable 437. Electrical signals in the cable 437 control the flow of printing substance from the cartridge 450 onto the surface. The mounting of the cartridge 450 can be made with any type of connecting means to include bolts, clips or adhesives and may include spacers or other elements to properly secure and position the cartridge 450.

For the embodiment of FIG. 4, as detailed in FIG. 2, a longitudinal fly-wheel and pulley assembly 239 provides the movement mechanism to receive instructions from the control panel 249 to move the frame 232 bi-directionally on the longitudinal rails 231. The fly-wheel assembly 239 includes a motor that rotates the fly-wheel that moves a belt 235 connected to the frame 232 and therefore moves the frame 232 up and down the axis of the rail 231.

It is contemplated that the means to move the cartridge may also include regulating the distance to the printing surface from the cartridge while the cartridge is moving over the non-uniform surface.

It is contemplated that the means to move the cartridge may also include moving the printing surface relative to the cartridge or having multiple nozzles that can create an image without the need to move the nozzles.

It is also contemplated that the means to move the cartridge may also include actuators that engage threaded rods across different axes. The rotation of these rods can engage the traditional base or the cartridge base and move the opening about the surface.

### Means to Control the Movement and Release

The means to control the movement of the opening and the release of the substance is provided by the control assembly. The control assembly allows the image creating apparatus to control the release of the printing substance and create an image.

It is understood that the control assembly may generally be realized in hardware, software, or any combination of these suitable for the control techniques described herein. The control assembly may be realized in one or more microprocessors, microcontrollers, embedded microcontrollers, programmable digital signal processors or other programmable device, along with internal and/or external memory. The control assembly may also, or instead, include an application specific integrated circuit, a programmable gate array, programmable array logic, or any other device that may be configured to process electronic signals. It will further be appreciated that the control assembly may also, or instead, include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above assemblies, as well as heterogeneous combinations of processors, processor architectures, or combinations of different hardware and software. Additionally, processing may be distributed across the assemblies and any one or more supporting processors or co-processors in a number of ways, or all of the functionality may be integrated into a dedicated, standalone assembly. All such permutations and combinations are intended to fall within the scope of the present disclosure.

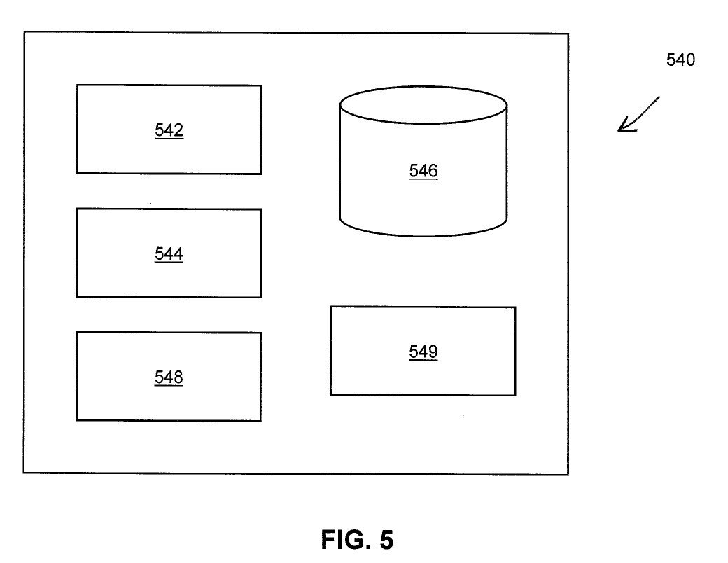

In the embodiment shown in FIG. 5, the means of control is provided by a control assembly 540 comprising a computer with interconnected components comprising a processor 542, computer executable code 544, memory 546, a user interface 548, a control panel 549 and a power source.

In this embodiment, the processor 542 is capable of retrieving and executing the computer executable code 544 stored in memory 546, communicating with the user interface 548 to receive the user input, processing those instructions from the user input and translating that input into instructions for the control panel 549. The control panel 549 then communicates those instructions onto the apparatus elements to control the actuation and movement assemblies. The term instructions as used in this description can include signals that can be communicated and interpreted by elements and can include, but are not limited to electrical pulses, radio signals, infrared radiation and computer data.

The computer executable code 544 may also be used to load, modify, reproduce or otherwise control the image to be created on the surface. A graphic program such as Photoshop sold by Adobe Systems Inc. of San Jose Calif. is an example of the type of computer executable code 544 that is capable of accepting the user input, controlling the image and communicating instructions to the control panel.

The memory 546 may include without limitation, flash memory, random access memory, dynamic random access memory, a disk drive, a tape drive, an optical drive, or any other components of the control assembly suitable for use with the assemblies described.

The user interface 548 may include without limitation, a keyboard, mouse, touchpad, audio receiver or other means of receiving a command from an individual user or another system functioning as the user of this control assembly and communicating that command as a signal or data.

In this embodiment, the control panel 549 is described as part of the control assembly 540, but it is recognized that its functionality may be distributed among other elements of the apparatus. For example, in many embodiments where the printing assembly is similar to a traditional inkjet printer, some control panel functionality resides in the printer, some resides in the printer cartridge and other functionality resides in a computer connected to the printer. For those embodiments where functionality of the control panel is distributed, the control assembly may also include without limitation, an electronic, signal or any other connection means that allows the control assembly to communicate a signal to those other distributed control panel components. In embodiments with distributed control panel functionality, the distributed control panel components may also each include a processor, computer executable code, memory, a user interface and a power source.

A computer such as the DELL Latitude D600 sold by Dell Computer of Round Rock Tex. with an Intel Pentium M 1.80 GHz processor, 512 MB RAM, an 80 GB hard drive and a printing port is suitable for use as the computer in one embodiment.

It is understood that in some embodiment, the control assembly can communicate directly to the movement and actuation assemblies without having to communicate through a control panel. It is also understood that the control assembly can allow image selection to be provide using pre-set images or images selection through means other than individual user input.

### The Surface:

As shown in FIG. 1 also, the printing assembly 120 is used with a surface 160 to create the image 110. The surface can comprise any material capable of receiving and retaining the printing substance. The surface is capable of either absorbing the substance into the surface or supporting the printing substance on the surface.

For surfaces that absorb the printing substance, the surface should minimize the dispersion of the coloring of the substance. An example of this type of surface includes but is not limited to the surface of crème brûlée, whip cream or rice paper.

For surfaces, such as that shown in FIG. 6, where the surface 660 supports the printing substance on a matrix of bubbles, the composition of the bubbles must support the receipt of the printing substance. FIG. 6 shows a surface 660 comprising a liquid film of a matrix of liquid bubbles toplayer 662 floating on a sublayer 664 retained in a cup 668. An example of suitable surfaces to support the printing substance includes but is not limited to a dairy based foam typical of that found on a normal cappuccino beverage, a dairy based whipped cream or a soap and water based foam.

In embodiments where the surface comprises a matrix of bubbles, the non-uniform surface also provides the benefit of containing the movement of the printing substance on the surface. The printing substance is able to be retained within the “peaks” and “valleys” created by the bubbles. Even if some bubbles are penetrated and broken, the underlying bubbles, and the new peaks and valleys help contain the printing substance. Additionally, even if the droplets from the cartridge are released at a DPI of one value and the non-uniform surface, because of it's shape or composition, promotes the combining of droplets reflecting a DPI of another value on the surface, the containment of the printing substance can help create a resolution, or DPI on the surface that still provides a detailed image. To create a detailed image, resolution can comprise a DPI on the surface between 10 and 1200, or preferably between 96 and 1200 DPI or more preferably 96 and 300 DPI

Another advantage of embodiments with a matrix of bubbles is that the matrix of bubbles help isolate the printing substance from the external heat of the liquid.

In some embodiments, the surface is a toplayer suspended over an underlayer. The underlayer can be any material to include solids or liquids that support the surface. The underlayer can be an ingestible liquid such as a beverage. For one embodiment, the underlayer is a coffee-based beverage, the surface is a milk based foam and the ink is a caramel based liquid.

It is understood that the surface can also be the surface of a single underlayer.

### ALTERNATIVE EMBODIMENTS OF THE IMAGE CREATING APPARATUS

One embodiment of the image creating apparatus includes a non-edible ink as the printing substance. In this embodiment, the ink has similar properties to the substance described above without the property of being ingestible.

One embodiment of the apparatus comprises integrating the apparatus into an automated beverage machine so that a custom image can be automatically created by the machine after the beverage is served.

In another embodiment, the cartridge and printing substance can be replaced with a simple etching straw to controllably pierce the toplayer of a beverage and expose the sublayer of the beverage thereby creating an image.

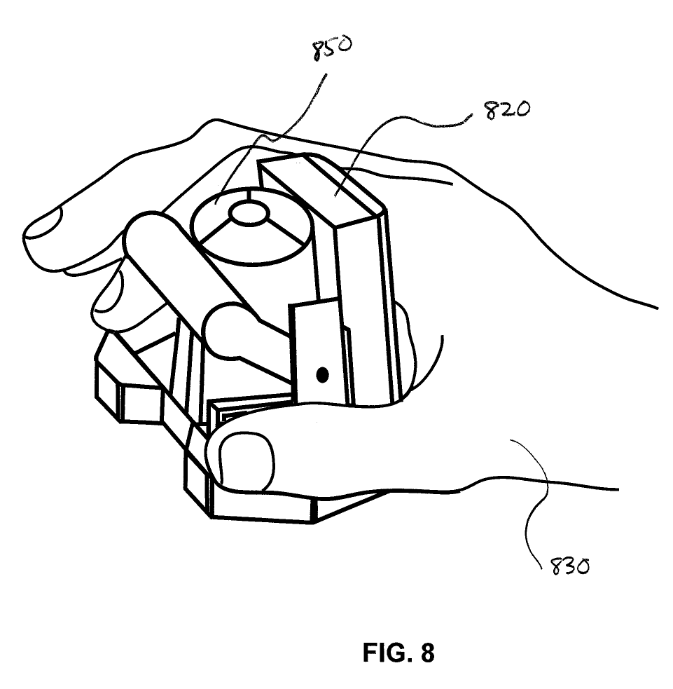

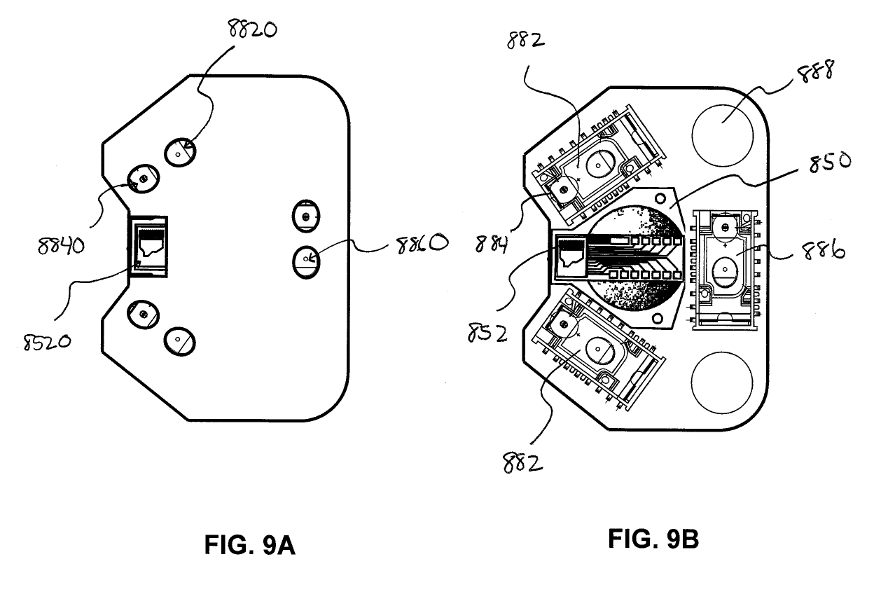

In another embodiment, shown in FIGS. 8, 9A and 9B, it is possible to implement this apparatus with a processor, memory, computer executable code, control assembly, cartridge and printing substance are all embedded into a small device that uses navigation and/or proximity sensors to control the flow of the printing substance onto the surface of the beverage.

### Operation of the Image Creating Apparatus:

The operational methods of use for the image creating apparatus are described below for illustration purposes and not for limitation. The methods below describe operational use with beverage based liquids and printing substances, but it is understood that other methods of use are contemplated as would be apparent and obvious to those skilled in the art. For example, the apparatus and methods disclosed are suitable for use with non-ingestible liquids and surfaces as may be encountered in the manufacture of chemicals. It is also understood that the methods of use do not require a liquid sublayer as may be encountered when placing a layer of foam over a separate, non-liquid surface.

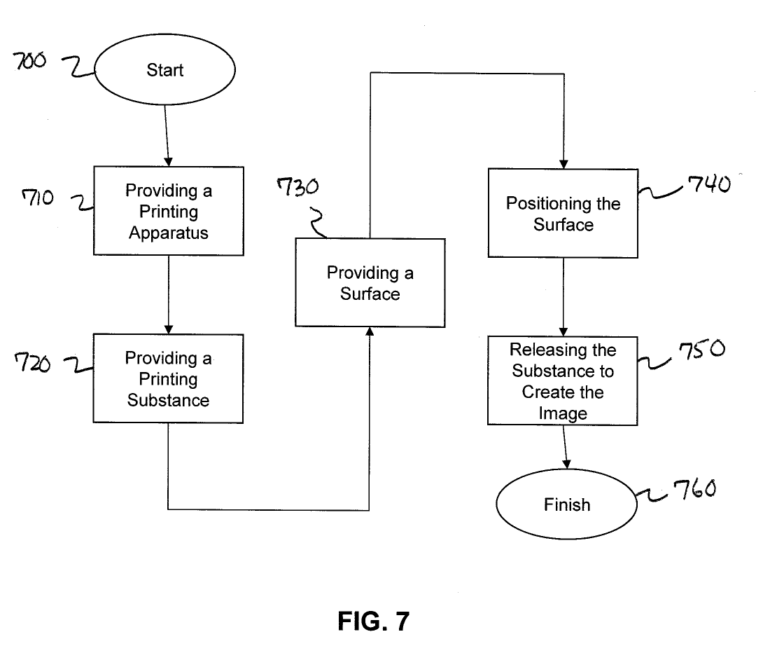

For illustrative purposes, the following steps and the process diagram shown in FIG. 7 describe the operational use of the image creating apparatus shown in FIG. 1. This example uses a printing assembly similar to a flatbed inkjet printer, a caramel based printing substance and a liquid foam printing surface on a beverage based sublayer.

After the start of the process, step 700, the printing apparatus is provided at step 710. Any printing apparatus as described earlier is suitable for use with this embodiment. In this embodiment, the printing assembly comprises a cartridge with a reservoir and multiple openings and an actuator assembly to release the printing substance from the reservoir. The printing assembly also includes a movement assembly and a control assembly.

At any time prior to creating the image, a printing substance is provided in step 720 and placed in the reservoir. In one embodiment, the printing substance comprises a caramel based liquid.

With step 730, a surface is also provided onto which the printing substance can be released. For embodiments that include a liquid underlayer, the surface is created by priming the liquid sublayer so that a matrix of bubbles forming a toplayer of foam is formed on the sublayer. It is possible for this toplayer to be made from agitation of the liquid sublayer or it may also be made from agitation of a separate toplayer that is placed onto the liquid sublayer. For example, in embodiments with a sublayer comprising hot coffee based beverages, some portion of the beverage is primed by steaming or frothing and mixing it in with hot coffee. As a result, a toplayer of bubbles is formed on the surface of the beverage. Such toplayer provides adequate isolation for printing substance droplets, so that the image can stay consistent for a period of time at least long enough for the beverage to be served. Many beverages, such as latte coffee, cappuccino and other milk based coffees already include such step as part of the frothing process and/or they have a toplayer of foam. Some beverages, such as plain espresso have a layer of naturally formed cream as a thin toplayer of natural foam as part of the brewing process. Beverages with existing toplayers do not always need priming, and can be used for image displaying described in this invention directly. Instead of priming the beverage directly, it is also possible to deposit a toplayer of foam on top of the beverage sublayer prior to creating the image. FIG. 6 shows the cross-section of one embodiment of a toplayer surface of foam on a liquid underlayer of coffee held in a cup.

It is understood that other methods of forming a toplayer surface on the sublayer can be used, such as, but not limited to applying piezoelements, forcing air or compressed air into a liquid, or adding floatable solutions or elements to the liquid sublayer.

With the surface, printing substance and the printing assembly provided, the image may be created.

In step 740, the surface is positioned under the cartridge so that the cartridge hovers over the surface of the beverage. It is understood that some embodiments of the apparatus can include a translation stage that senses and adjusts the proximity of surface to the cartridge opening or the printing assembly. This translation stage can include, without limitation, optical, temperature or radio frequency sensors that are capable of creating and communicating position data to the control assembly so that it can determine the location of the surface relative to the cartridge openings.

The above steps can be performed in any order. In this embodiment, the above steps need to be completed prior to creating the image.

Step 750 comprises releasing the substance to create the image. For embodiments as shown in FIG. 1 that include a computer or processor based control assembly, the user interface allows the user create or select the image to be created by interacting with the user interface. The user interface shares data with control assembly that uses the processor and computer executable code stored in memory to interpret this user input and translates that into instruction data for the control assembly. The control assembly then communicates this instruction data to the movement assembly and the actuation assembly to move the opening and release the printing substance to create the image on the surface. As the cartridge is moved over the surface, the flow of the printing substance through the cartridge opening is turned on and off, so that an image can be created.

For computer based embodiments of the control assembly, it is understood that the image can be selected interactively by the user of the invention or can be uploaded automatically into the memory by the processor executing computer executable code stored in the memory. The image selection can also include confirmation of the user input.

When the process completes at step 760, the result is an image on the surface. In this embodiment, the result can be an image with a resolution, or DPI on the surface, between 10 and 1200, or preferably between 32 and 1200 DPI or more preferably 32 and 300 DPI.

### OPERATION OF ALTERNATIVE EMBODIMENTS

In an alternative embodiment of a printing assembly shown in FIG. 8, the cartridge 850 and printing assembly 820 are combined into a hand-held printing assembly. With this embodiment, it is envisioned that a human hand 830 acts as the movement assembly and the user rapidly moves the apparatus randomly over the surface of the beverage. During this movement, the assembly 820 recognizes the location and orientation of the opening and actuates the release of the substance at locations to create an image. The bottom of the printing assembly 820 is shown in FIGS. 9A and 9B. FIG. 9A shows the bottom illustrating navigation sensor openings 882O and VCSEL laser openings 884O through which sensors collect and share position data regarding the cartridge 850. Nozzle opening 852O, through which the printing substance is released, is also shown. FIG. 9B illustrates the bottom of the printing assembly with the bottom cover removed. This view shows the navigation sensors 882, the VCSEL laser 884, the optional tilt sensor 886, batteries 888 and the bottom of the cartridge 850 to include the opening 852. In this embodiment, the printing assembly includes at least two navigation sensors 882 in communication with the control assembly to provide position and orientation data of the cartridge 850. The sensors 882, 884 and 886 are similar to those used in a LED/Laser operated mouse and examples include without limitation the LaserStream Navigation sensors sold by Avago Technologies from San Jose, Calif. The control assembly is able with the position and orientation data, through computer executable code, to determine the orientation of the cartridge and its openings. Functionally, as the user moves the printing assembly above the surface, the position of the sensors can be determined with high precision by the control assembly. With this embodiment, the user can signal with a start button that the printing assembly is over one specific reference point of the cup, such as the left edge. With this signal, the control assembly determines the orientation of the printing assembly based on positioning differences from that specific point and sends out pulses to the cartridge in order to release the printing substance. It is possible to have an embodiment where two sensors are used to determine x-y coordinates if the assembly can be maintained in a somewhat consistent z plane. Preferrably, three sensors are use to determine the three dimensional orientation of the cartridge.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Although this invention has been described in the above forms with a certain degree of particularity, it is understood that the present disclosure has been made only by way of example and numerous changes in the details of construction and combination and arrangement of parts may be resorted to without departing from the spirit and scope of the invention.

1. A image creating apparatus, said apparatus comprising:
a printing assembly comprising a reservoir and at least one opening;
the reservoir containing a liquid substance;
a surface of a liquid sublayer; and
the printing assembly further comprises a means to release the substance from the opening onto the surface.

2. The image creating apparatus of claim 1 wherein the surface comprises a foam surface on the liquid sublayer.

3. The image creating apparatus of claim 1 wherein the surface comprises a liquid film surface on the liquid sublayer.

4. The image creating apparatus of claim 1 wherein the means to release the substance from the opening onto the surface is capable of releasing the substance at a resolution of at least about 10 dots per inch.

5. The image creating apparatus of claim 1 wherein the liquid substance comprises a coloring having a uniform color spectrum as the substance dissolves in the liquid sublayer.

6. The image creating apparatus of claim 1 wherein the liquid sublayer includes a coloring having a color spectrum and the liquid substance includes a coloring having the same color spectrum.

7. The image creating apparatus of claim 1 wherein:
the liquid substance is ingestible; and
the surface is ingestible.

8. The image creating apparatus of claim 1 wherein:
the liquid substance comprises a caramel;
the surface comprises a dairy based foam surface; and
the surface is floating on the liquid sublayer comprising a coffee based liquid.

9. The image creating apparatus of claim 1 wherein:
the means to release the liquid substance comprises an actuation assembly; and
the actuation assembly comprising a power source, a resistor proximal to the opening and a control panel electronically connected to the resistor whereby the actuation assembly is capable of transferring a pulse of electrical current from the power source to the resistor to release the liquid substance.

10. The image creating apparatus of claim 9 wherein:
the printing assembly further comprises a movement assembly and a control assembly;
the movement assembly is capable of moving the opening in at least two dimensions; and
the control assembly comprises a processor, memory and computer executable code capable of communicating with the movement assembly and the actuation assembly.

11. An image creating apparatus to create an image, said apparatus comprising:
a printing assembly comprising a reservoir and at least one opening;
the reservoir containing a liquid substance; and
an actuation assembly to release the liquid substance from the at least one opening across a plurality of distances onto a surface to create an image having a resolution on the surface of at least about 10 dots per inch.

12. The image creating apparatus of claim 11 wherein the actuation assembly comprises a power source, a resistor proximal to the opening and a control panel electronically connected to the resistor whereby the actuation assembly is capable of transferring a pulse of electrical current from the power source to the resistor to release the liquid substance.

13. The image creating apparatus of claim 11 wherein the plurality of distances varies more than about 7.5 millimeters.

14. The image creating apparatus of claim 11 wherein the plurality of distances is at least about 7.5 millimeters.

15. The image creating apparatus of claim 11 wherein:
the printing assembly further comprises a movement assembly and a processor based control assembly;
the movement assembly is capable of moving the opening in at least two dimensions; and
the processor based control assembly comprises a processor, memory and computer executable code capable of communicating with the movement assembly and the actuation assembly.

16. A method of creating an image comprising the steps of:
providing a printing assembly comprising a reservoir with at least one opening;
providing a liquid substance contained in the reservoir;
providing a surface on a liquid sublayer; and
releasing the liquid substance from the at least one opening onto the surface to create an image.

17. The method of claim 16 wherein the step of providing a surface comprises providing a foam surface floating on the liquid sublayer.

18. The method of claim 16 wherein the step of providing a surface comprises providing a liquid film surface floating on the liquid sublayer.

19. The method of claim 16 wherein the step of providing a surface comprises agitating a liquid toplayer to create a surface of a mass of bubbles of gas in a matrix of liquid toplayer film.

20. The method of claim 16 wherein the step of releasing the substance comprises:
moving the at least one opening over the surface with a movement assembly;
releasing the liquid substance from the reservoir with an actuation assembly; and
controlling the movement assembly and the actuation assembly with a control assembly whereby the release of the liquid substance onto the surface creates an image having a resolution on the surface of at least about 10 dots per inch.

21. The method of claim 20 wherein:
the control assembly is capable of storing an image in a memory; and
the step of controlling the movement assembly and the actuation assembly further comprising retrieving the image from the memory and communicating with the movement and actuation assembly to create the image from the memory.

22. A method of printing an image comprising the steps of:
providing a printing assembly comprising a reservoir with at least one opening;
providing a liquid substance contained in the reservoir;
providing a non-uniform liquid surface; and
releasing the substance from the at least one opening across a plurality of distances onto the non-uniform liquid surface to create an image having a resolution on the surface of at least about 10 dots per inch.

23. The method of claim 22 wherein the non-uniform liquid surface comprises a non-uniform liquid surface on a liquid toplayer.
